(19) United States
(12) Patent Application Publication
(10) Pub. No.: US 2026/0086386 A1
(43) Pub. Date: Mar. 26, 2026

(54) LIGHT EMITTING DEVICE

(71) Applicant: GUANGZHOU LUXVISIONS INNOVATION TECHNOLOGY LIMITED, Guangzhou City (CN)

(72) Inventor: Chuan-Hui Liu, Guangzhou City (CN)

(73) Assignee: GUANGZHOU LUXVISIONS INNOVATION TECHNOLOGY LIMITED, Guangzhou City (CN)

(21) Appl. No.: 19/173,848

(22) Filed: Apr. 9, 2025

Related U.S. Application Data
(60) Provisional application No. 63/699,774, filed on Sep. 26, 2024.

(30) Foreign Application Priority Data
Jan. 8, 2025 (CN) 202510030704.1

(51) Int. Cl. G02B 27/30; G02B 3/14; G02B 26/00

(52) U.S. Cl. CPC G02B 27/30; G02B 3/14; G02B 26/004

(57) ABSTRACT

The disclosure provides a light emitting device, including: a light source, used to emit a beam; a collimation lens, located on an optical path of the beam and used to collimate the beam; and a liquid lens, located on the optical path of the beam. A divergence angle of the beam is changed through changing a refractive power of the liquid lens.

### CROSS-REFERENCE TO RELATED APPLICATION

This application claims the priority benefit of U.S. provisional application Ser. No. 63/699,774, filed on Sep. 26, 2024, and China application serial no. 202510030704.1, filed on Jan. 8, 2025. The entirety of each of the above-mentioned patent applications is hereby incorporated by reference herein and made a part of this specification.

### BACKGROUND

### Technical Field

The disclosure relates to a light emitting device.

### Description of Related Art

When taking photos, it is common to use a flash to fill the light. However, the light emitted by the flash often scatters into the environment instead of being focused on the subject, resulting in poor fill light efficiency. Therefore, there is a need for a system that can improve the light focusing ability of the flash.

### SUMMARY

Some embodiments of the disclosure provide a light emitting device, including: a light source, used to emit a beam; a collimation lens, located on an optical path of the beam and used to collimate the beam; and a liquid lens, located on the optical path of the beam. A divergence angle of the beam is changed through changing a refractive power of the liquid lens.

Therefore, through the light emitting device provided by the disclosure, the refractive power of the liquid lens may be changed through energizing to change an illumination range of the beam, and maintain the uniformity of a light field within the illumination range.

### BRIEF DESCRIPTION OF THE DRAWINGS

FIG. 1 is a schematic diagram of a light emitting device according to an embodiment of the disclosure.

FIG. 2A and FIG. 2B are schematic diagrams of a liquid lens according to an embodiment of the disclosure.

FIG. 3A is a schematic diagram of a light emitting device according to an embodiment of the disclosure.

FIG. 3B is a schematic diagram of a light emitting state of the light emitting device shown in FIG. 3A.

FIG. 4A is a schematic diagram of a light emitting device according to an embodiment of the disclosure.

FIG. 4B is a schematic diagram of a light emitting state of the light emitting device shown in FIG. 4A.

FIG. 5A is a diagram of a light field distribution of a light emitting device in a light emitting state according to the disclosure.

FIG. 5B is a diagram of a light field distribution of a light emitting device in a light emitting state according to the disclosure.

FIG. 6A is a diagram of a light field distribution of a light emitting device in a light emitting state according to the disclosure.

FIG. 6B is a diagram of a light field distribution of a light emitting device in a light emitting state according to the disclosure.

### DESCRIPTION OF THE EMBODIMENTS

The following lists embodiments and describes the embodiments in detail with reference to the drawings, but the embodiments provided are not intended to limit the scope of the disclosure. In addition, the sizes of components in the drawings are drawn for the convenience of explanation and do not represent the actual size ratios of the components. Furthermore, although terms such as “first” and “second” are used herein to describe different components and/or film layers, the components and/or the film layers should not be limited to the terms. Rather, the terms are only used to distinguish one component or film layer from another component or film layer. Therefore, a first component or film layer discussed below may be referred to as a second component or film layer without departing from the teachings of the embodiments. For easier understanding, similar components will be described below with the same numerals.

In describing the embodiments of the disclosure, different examples may use repeated reference numerals and/or terms. The repeated numerals or terms are for the purpose of simplicity and clarity, and are not used to limit the relationship between various embodiments and/or described appearance structures. Furthermore, if the following invention content of the specification describes that a first feature is formed on or above a second feature, it means that the same includes an embodiment in which the first feature and the second feature are in direct contact, and also includes an embodiment in which an additional feature is formed between the first feature and the second feature, so that the first feature and the second feature may not be in direct contact. For easier understanding, similar components will be described below with the same numerals.

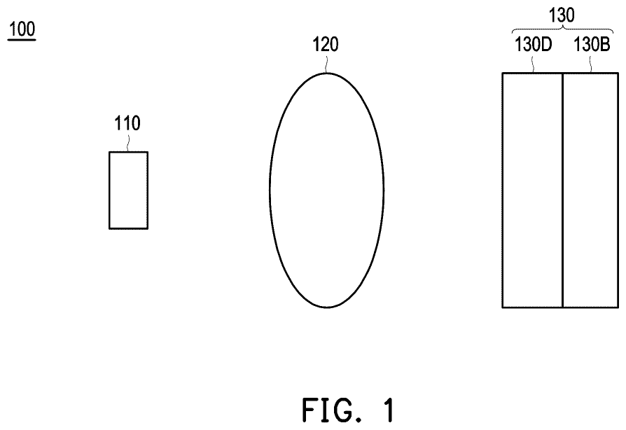

FIG. 1 is a schematic diagram of a light emitting device according to an embodiment of the disclosure.

Please refer to FIG. 1. As shown in FIG. 1, a light emitting device 100 includes a light source 110, a collimation lens 120, and a liquid lens 130.

The light source 110 is used to emit a beam L. In some embodiments, the light source 110 is a white light emitting diode (LED), a monochromatic LED such as a red LED, a green LED, or a blue LED, or other sources with similar functions, but the disclosure is not limited thereto. In some embodiments, the light source 110 may be composed of one LED or an array of multiple LEDs, but the disclosure is not limited thereto. In some embodiments, the beam L is white light or monochromatic light such as red light, green light, or blue light, but the disclosure is not limited thereto.

The collimation lens 120 is located on an optical path of the beam L and is used to collimate the beam L. In some embodiments, the collimation lens 120 has a positive refractive power. In some embodiments, the collimation lens 120 is a convex lens, a Fresnel lens, a meta-lens, or other lenses with similar functions, but the disclosure is not limited thereto.

The liquid lens 130 is located on the optical path of the beam L. A divergence angle of the beam L is changed through changing the refractive power of the liquid lens 130. As shown in FIG. 1, the liquid lens 130 includes a liquid layer 130B and a substrate 130D. The specific structure of the liquid lens 130 will be described below.

Therefore, the light source 110 emits the beam L, which is collimated by the collimation lens 120 and is then incident on the liquid lens 130. Through changing the refractive power of the liquid layer 130B of the liquid lens 130, the divergence angle of the beam L may be changed to meet actual application requirements.

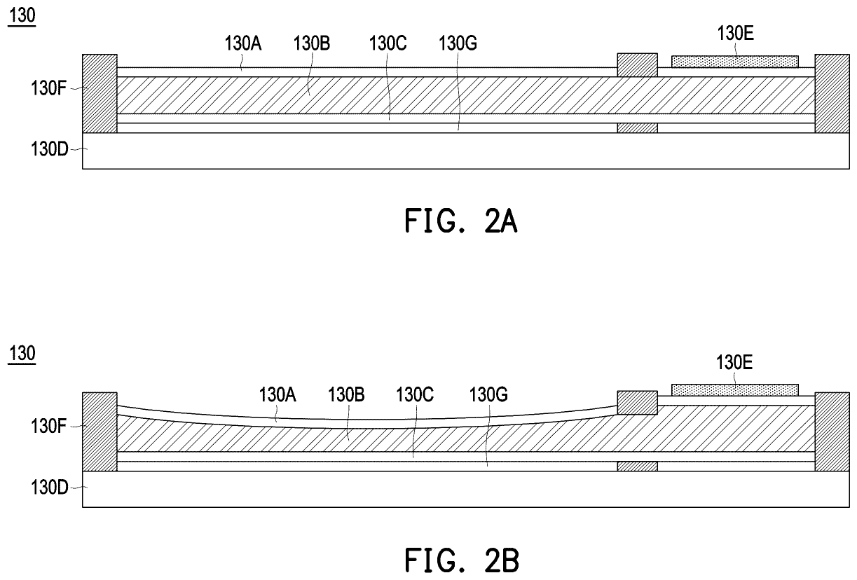

FIG. 2A and FIG. 2B are schematic diagrams of a liquid lens according to an embodiment of the disclosure.

Please refer to FIG. 2A and FIG. 2B at the same time. As shown in FIG. 2A and FIG. 2B, the liquid lens 130 includes an electrode layer 130A, a liquid layer 130B, an electrode layer 130C, a substrate 130D, an electrode 130E, a frame 130F, and an air layer 130G.

The electrode layer 130A, the electrode layer 130C, and the liquid layer 130B are all disposed on the substrate 130D. The electrode layer 130A and the electrode layer 130C are used to encapsulate the liquid layer 130B and limit a liquid in the frame 130F to form a closed space, so that the liquid layer 130B does not leak out. The electrode 130E is electrically connected to the electrode layer 130A and the electrode layer 130C.

The air layer 130G is located between the electrode layer 130C and the substrate 130D.

In the embodiment, the shape of the liquid layer 130B is changeable to change the refractive power of the liquid lens 130.

Please refer to FIG. 2A. As shown in FIG. 2A, when the electrode 130E does not energize the electrode layer 130A and the electrode layer 130C, the electrode layer 130A and the electrode layer 130C do not deform. At this time, the electrode layer 130A, the liquid layer 130B, and the electrode layer 130C form a structure similar to a plane lens, and the refractive index is zero or substantially zero.

Please refer to FIG. 2B. As shown in FIG. 2B, when the electrode 130E energizes the electrode layer 130A and the electrode layer 130C, the electrode layer 130A and the electrode layer 130C are deformed, thereby changing the shape of the liquid layer 130B. At this time, the electrode layer 130A, the liquid layer 130B, and the electrode layer 130C form a structure similar to a concave lens, and the refractive index is not zero. Specifically, at this time, the refractive power of the optical structure formed by the electrode layer 130A, the liquid layer 130B, and the electrode layer 130C is less than zero.

Since the liquid lens 130 may switch between the plane lens (a non-energized state) and the concave lens (an energized state) according to the energizing state, the maximum value of the refractive power of the liquid lens 130 is substantially 0, that is, the plane lens. When the refractive power of the liquid lens 130 is not 0, the liquid lens 130 is the concave lens.

In the embodiment, the electrode layer 130A and the electrode layer 130C may have different curvatures to change the shape of the liquid layer 130B, so as to change the refractive power of the optical structure formed by the electrode layer 130A, the liquid layer 130B, and the electrode layer 130C.

In the embodiment, the electrode layer 130C is connected to the air layer 130G, so the shape of the electrode layer 130C may change freely, which increases the variability of the shape of the liquid layer 130B.

In some embodiments, the electrode layer 130A and the electrode layer 130C are made of a light transmitting conductive material, such as indium tin oxide (ITO) or other materials with similar properties, but the disclosure is not limited thereto.

In some embodiments, the liquid layer 132B is a light transmitting optical liquid, such as silicone oil, mineral oil, fluorinated liquid, or other materials with similar properties, but the disclosure is not limited thereto.

In some embodiments, the air layer 130G may also be filled with other liquids, wherein the refractive index of the filled liquid is different from the refractive index of the liquid layer 130B, so as to change the optical properties of the liquid lens 130.

In some embodiments, the air layer 130G of the liquid lens 130 may be omitted, so that the electrode layer 130C is connected to the substrate 130D, so as to reduce the volume of the liquid lens 130. However, since the electrode layer 130C is connected to the substrate 130D, the shape of the electrode layer 130C cannot be changed, so that the deformation of the liquid layer 130B is limited.

In some embodiments, the substrate 130D is a transparent substrate, such as a glass substrate or a plastic substrate, or other materials with similar properties, but the disclosure is not limited thereto.

As described above, when the liquid layer 130B of the liquid lens 130 is deformed due to the energization of the electrode layer 130A and the electrode layer 130C, the liquid layer 130B may have a spherical surface or an aspherical surface. When the liquid layer 130B of the liquid lens 130 includes the aspherical surface, the aspherical surface of the liquid layer 130B of the liquid lens 130 may be expressed by Equation 1.

$$Z = \frac{{cr}^{2}}{1 + \sqrt{1 - ( 1 + k ) {c}^{2} {r}^{2}}} + {A}_{4} {r}^{4} + {A}_{6} {r}^{6} + {A}_{8} {r}^{8} + {A}_{10} {r}^{10} + … \qquad [ Equation 1 ]$$

In Equation 1, c is an inverse of a radius of curvature of the liquid layer 130B of the liquid lens 130, k is a conic constant, r is a distance from any point on the aspherical surface to an optical axis, A₄, A₆, A₈, and A₁₀ are aspherical surface constants, and Z is a height from a point on the aspherical surface to the vertex of the corresponding aspherical surface in the direction of the optical axis.

Table 1 and Table 2 show the lens characteristics of the light emitting device 100 according to the embodiment, and Table 3 shows the lens characteristics and the aspherical values of the liquid layer 130B of the liquid lens 130 of the light emitting device 100 according to the embodiment. In Table 1, the gas layer 130G is not included.

TABLE 1

| Surface | | Radius of | Thickness/ | Refractive | Abbe |
|---|---|---|---|---|---|
| number | Component | curvature | Distance | index | number |
| S0 | Object | Infinite | 3 | | |
| S1 | Collimation | 2.1 | 1 | 1.540 | 56.000 |
| | lens 120 | | | | |
| S2 | | Infinite | 0.5 | | |
| S3 | Substrate 130D | Infinite | 0.21 | 1.520 | 54.4 |
| S4 | Electrode | Infinite | 0.025 | 1.410 | 44.900 |
| | layer 130C | | | | |
| S5 | liquid layer 130B | Infinite | t5 | 1.290 | 92.500 |
| S6 | Electrode | r6 | 0.075 | 1.410 | 49.900 |
| | layer 130A | | | | |
| S7 | | r7 | t7 | | |
| S8 | | Infinite | 80 | | |
| S16 | | Infinite | | | |

TABLE 2

| | Non-energized | Energized |
|---|---|---|
| Parameter | (equivalent to plane lens) | (equivalent to concave lens) |
| r6 | Infinite | 3.000 |
| r7 | Infinite | 3.000 |
| t5 | 0.6 | 0.243 |
| t7 | 0.5 | 0.857 |

TABLE 3

| Surface number | S5 |
|---|---|
| k | 0 |
| A₄ | 7.3809E−02 |
| A₆ | −7.4780E−02 |
| A₈ | 2.2512E−02 |
| A₁₀ | −2.6146E−3 |

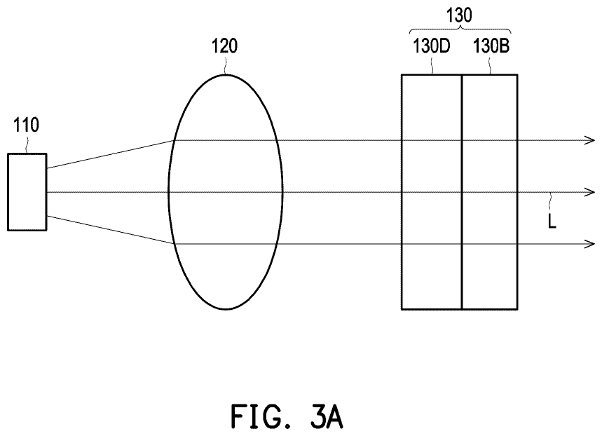

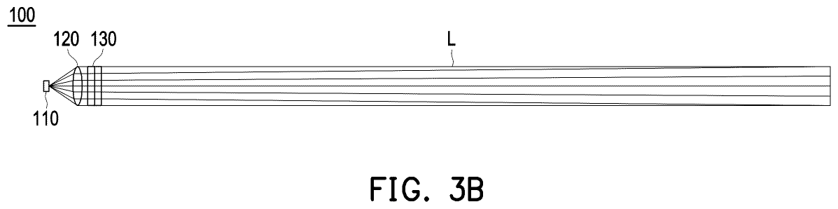

FIG. 3A is a schematic diagram of a light emitting device according to an embodiment of the disclosure. FIG. 3B is a schematic diagram of a light emitting state of the light emitting device shown in FIG. 3A. To simplify the illustration, only a partial structure of the liquid lens 130 is shown.

Please refer to FIG. 3A and FIG. 3B. As shown in FIG. 3A, the light source 110 emits the beam L, which is collimated by the collimation lens 120 and is then incident on the liquid lens 130. In FIG. 3A, the liquid lens 130 is not energized. At this time, the liquid layer 130B of the liquid lens 130 does not deform, so that the liquid lens 130 is equivalent to the plane lens. Therefore, the beam L may directly pass through the liquid layer 130B of the liquid lens 130 and maintain a collimated state to irradiate far away, as shown in FIG. 3B.

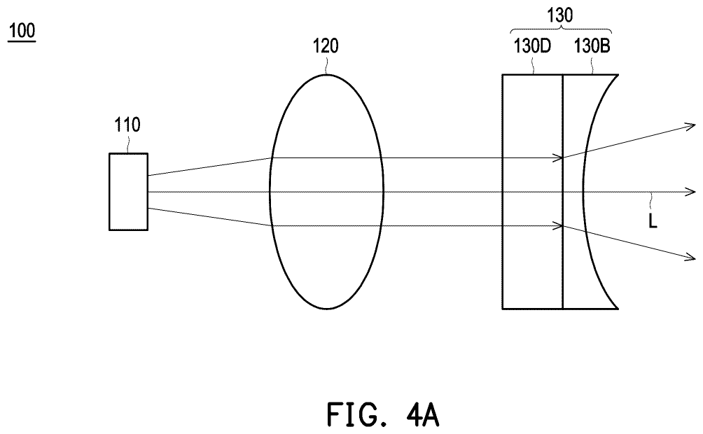

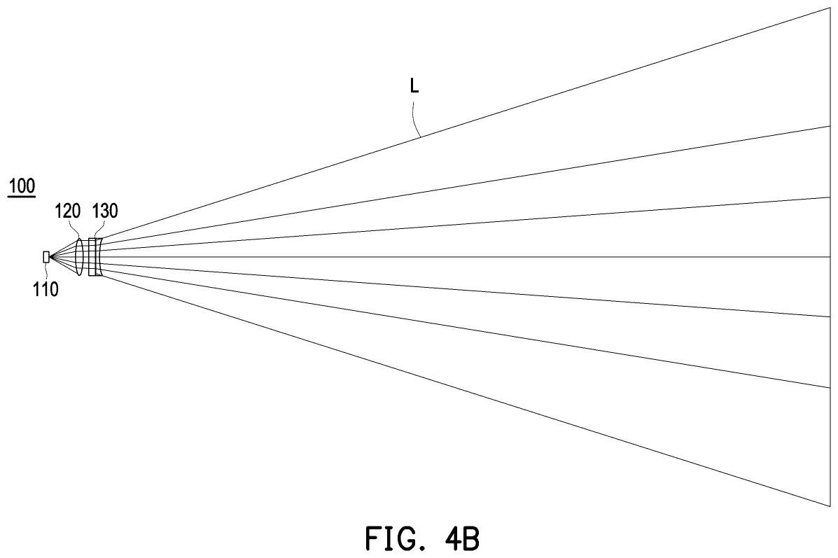

FIG. 4A is a schematic diagram of a light emitting device according to an embodiment of the disclosure. FIG. 4B is a schematic diagram of a light emitting state of the light emitting device shown in FIG. 4A. To simplify the illustration, only a partial structure of the liquid lens 130 is shown.

Please refer to FIG. 4A and FIG. 4B. As shown in FIG. 4A, the light source 110 emits the beam L, which is collimated by the collimation lens 120 and is then incident on the liquid lens 130. In FIG. 4A, the liquid lens 130 is energized. At this time, the liquid layer 130B of the liquid lens 130 is deformed, so that the liquid lens 130 is equivalent to the concave lens. Therefore, when the beam L passes through the liquid layer 130B of the liquid lens 130, the light path of the beam L is changed by the liquid layer 130B of the liquid lens 130, so that the beam L diverges and generates a larger illumination range far way, as shown in FIG. 4B.

In the embodiment, when the beam L is projected onto a plane perpendicular to the optical axis of the beam L, the radius of the projection range of the beam L increases as the absolute value of the refractive power of the liquid lens 130 increases.

For example, in FIG. 3B, since the liquid lens 130 is not energized, the absolute value of the refractive power is 0, so the radius of the projection range is smaller. In FIG. 4B, since the liquid lens 130 is energized, the liquid lens 130 has a negative refractive power, and the absolute value is greater than 0, so the radius of the projection range is larger. Also, the radius of the projection range increases as the absolute value of the refractive power increases.

In the embodiment, when the beam L is projected onto the plane perpendicular to the optical axis of the beam L, a ratio of the maximum radius to the minimum radius of the projection range of the beam L is greater than 5.

In the embodiment, when the beam L is projected onto the plane perpendicular to the optical axis of the beam L, the brightness uniformity of the projection range of the beam L is greater than 80%.

Therefore, through changing the refractive power of the liquid lens 130 of the light emitting device 100, the projection range of the beam L may be effectively expanded, and a certain brightness uniformity may be maintained within the projection range.

The following is illustrated with an example.

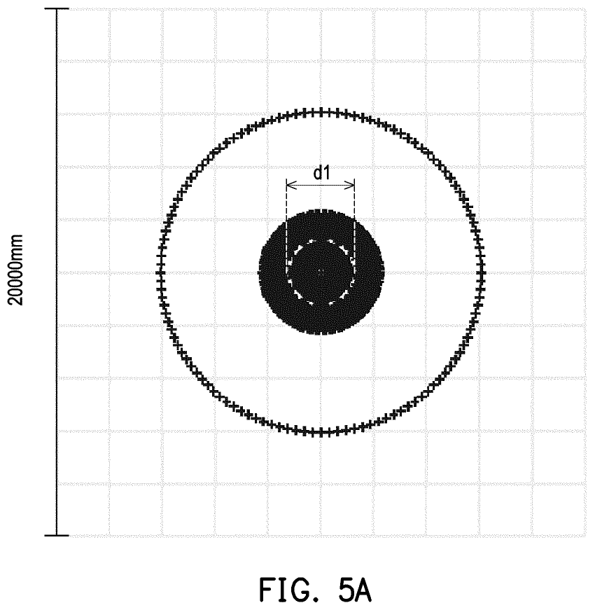

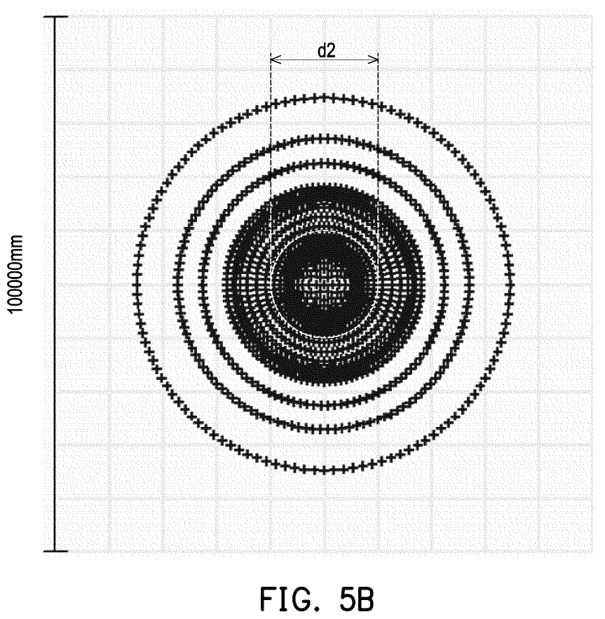

FIG. 5A is a diagram of a light field distribution of a light emitting device in a light emitting state according to the disclosure. FIG. 5B is a diagram of a light field distribution of a light emitting device in a light emitting state according to the disclosure.

Please refer to FIG. 5A. FIG. 5A is a computer simulation simulating the light field distribution of the beam L at a distance of 10 cm from the light source 110 when the liquid lens 130 of the light emitting device 100 is not energized, where d1 is a diameter of the projection range of the beam L where the brightness uniformity is greater than 80%. In the embodiment, d1 is 2240 μm, and the irradiation range diameter is 6661 μm.

Please refer to FIG. 5B. FIG. 5B is a computer simulation simulating the light field distribution of the beam L at a distance of 10 cm from the light source 110 when the liquid lens 130 of the light emitting device 100 is energized, where d2 is a diameter of the projection range of beam L where the brightness uniformity is greater than 80%. In the embodiment, d2 is 18000 μm, and the irradiation range diameter is 35000 μm.

Therefore, it can be known that in the embodiment, when the beam L is projected onto the plane perpendicular to the optical axis of the beam L, the ratio of the maximum radius to the minimum radius of the projection range of the beam L is greater than 5. For example, d2/d1=18000/2240−8.03. Therefore, through changing the refractive power of the liquid lens 130, the beam L may be effectively enlarged, the illumination area may be increased, and the uniformity of the beam L may be maintained.

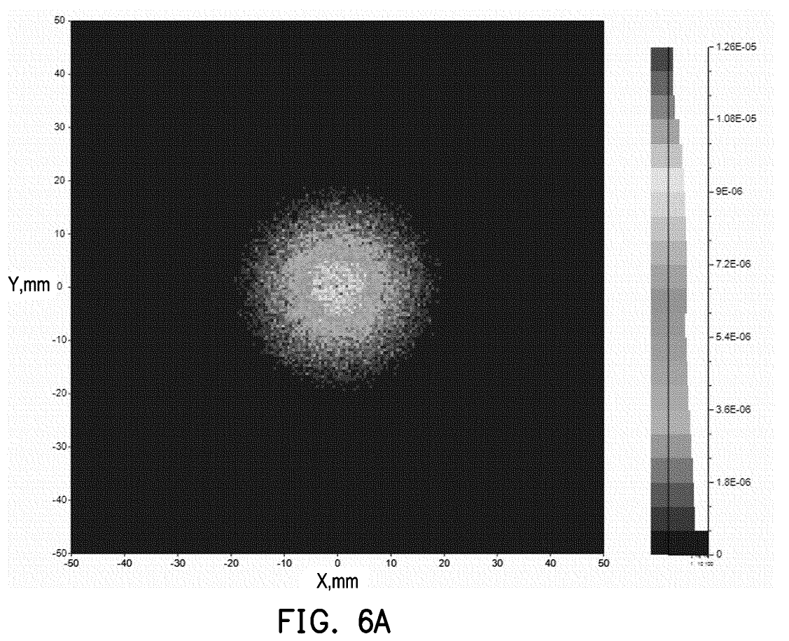

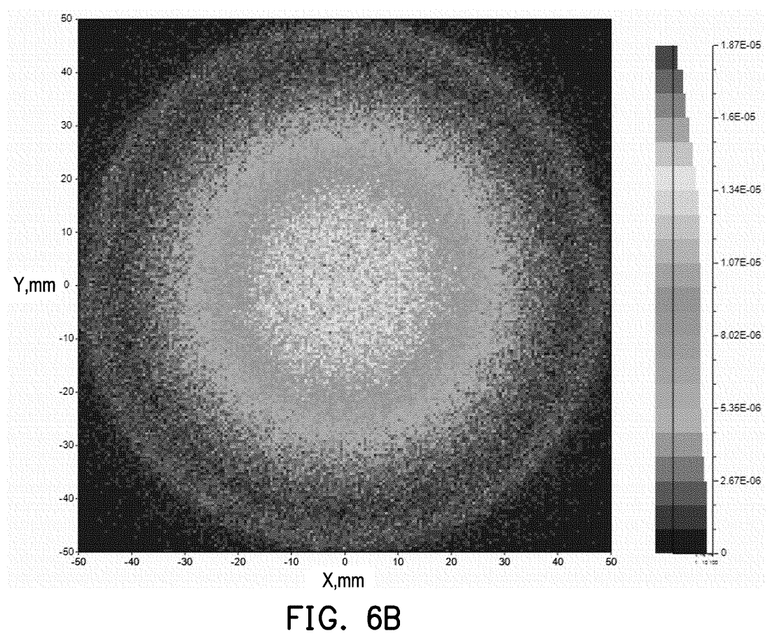

FIG. 6A is a diagram of a light field distribution of a light emitting device in a light emitting state according to the disclosure. FIG. 6B is a diagram of a light field distribution of a light emitting device in a light emitting state according to the disclosure.

Please refer to FIG. 6A and FIG. 6B at the same time. FIG. 6A is a computer simulation simulating the light field distribution of the beam L at a distance of 10 cm from the light source 110 when the liquid lens 130 of the light emitting device 100 is not energized. FIG. 6B is a computer simulation simulating the light field distribution of the beam L at a distance of 10 cm from the light source 110 when the liquid lens 130 of the light emitting device 100 is energized.

As shown in FIG. 6A, when the liquid lens 130 is not energized, the liquid lens 130 is equivalent to the plane lens. Therefore, the beam L emitted by the light source 110 is collimated by the collimation lens 120, and then passes through the liquid lens 130 equivalent to the plane lens to form a light speckle with a focused light field on a projection plane.

As shown in FIG. 6B, when the liquid lens 130 is energized, the liquid lens 130 is equivalent to the concave lens. Therefore, the beam L emitted by the light source 110 is collimated by the collimation lens 120, then passes through the liquid lens 130 equivalent to the concave lens, and is diverged by the liquid lens 130 to form a light speckle with a divergent light field on the projection plane. The illumination range is significantly larger than the situation in FIG. 6A when the liquid lens 130 is not energized.

Therefore, through the light emitting device provided by the disclosure, the refractive power of the liquid lens may be changed through energizing to change the illumination range of the beam, and maintain the uniformity of the light field within the illumination range.

What is claimed is:

1. A light emitting device, comprising:
a light source, used to emit a beam;
a collimation lens, located on an optical path of the beam and used to collimate the beam; and
a liquid lens, located on the optical path of the beam, wherein a divergence angle of the beam is changed through changing a refractive power of the liquid lens.

2. The light emitting device according to claim 1, wherein the light source is a white light emitting diode or a monochromic light emitting diode.

3. The light emitting device according to claim 1, wherein the beam is white light or monochromatic light.

4. The light emitting device according to claim 1, wherein the collimation lens is a convex lens, a Fresnel lens, or a meta-lens.

5. The light emitting device according to claim 1, wherein when the beam is projected onto a plane perpendicular to an optical axis of the beam, a ratio of a maximum radius to a minimum radius of a projection range of the beam is greater than 5.

6. The light emitting device according to claim 1, wherein when the beam is projected onto a plane perpendicular to an optical axis of the beam, a brightness uniformity of a projection range of the beam is greater than 80%.

7. The light emitting device according to claim 1, wherein a maximum value of the refractive power of the liquid lens is substantially 0.

8. The light emitting device according to claim 1, wherein when the beam is projected onto a plane perpendicular to an optical axis of the beam, a radius of a projection range of the beam increases as an absolute value of the refractive power of the liquid lens increases.

9. The light emitting device according to claim 1, wherein the liquid lens comprises: a liquid layer and an air layer, wherein a shape of the liquid layer is variable to change the refractive power of the liquid lens.

10. The light emitting device according to claim 1, wherein when the refractive power of the liquid lens is not 0, the liquid lens is a concave lens.
